(19) United States
(12) Patent Application Publication
(10) Pub. No.: US 2016/0097010 A1
(43) Pub. Date: Apr. 7, 2016

(54) STACKED SEPARATORS FOR PROCESSING GAS

(71) Applicant: PRIDE OF THE HILLS MANUFACTURING, INC., Big Prairie, OH (US)

(72) Inventors: Curtis W. Murray, SR., Big Prairie, OH (US); Curtis W. Murray, JR., Wooster, OH (US); Leroy P. Whited, Elyria, OH (US); Dustin Baker, Shreve, OH (US)

(73) Assignee: PRIDE OF THE HILLS MANUFACTURING, INC.

(21) Appl. No.: 14/873,657

(22) Filed: Oct. 2, 2015

Related U.S. Application Data
(60) Provisional application No. 62/060,899, filed on Oct. 7, 2014.

(51) Int. Cl. C10L 3/00; B01D 50/00

(52) U.S. Cl. CPC C10L 3/00; B01D 50/00; C10L 2290/06; C10L 2290/08; C10L 2290/567

(57) ABSTRACT

The gas processing apparatus of the present invention includes two pressure vessels, or two separators, above a single vessel footprint area in a vertically stacked configuration. The stacked configuration permits the processing of gas to occur in a space having less length and less width than that of two separators arranged tip-to-end or side-by-side, respectively. The first and second separators are configured to separate fuel from non-fuel in a footprint area of a single gas separator as the fuel moves from upstream to downstream through a gas processing system. Further, the gas processing apparatus of the present invention permits the two separators to fit in a housing compartment that is more easily transportable via tractor-trailer.

### CROSS REFERENCE TO RELATED APPLICATION

This application claims the benefit of U.S. Provisional Application Ser. No. 62/060,899, filed Oct. 7, 2014: the disclosure of which is entirely incorporated herein by reference.

### BACKGROUND OF THE INVENTION

1. Technical Field

The present invention relates generally to the field of fossil fuel processing devices. More particularly, the present invention relates to separators for separating fuel from non-fuels. Specifically, the present invention relates to a gas processing apparatus including at least two separators configured to separate fuel from non-fuel in a footprint area of a single gas separator as the fuel moves from upstream to downstream through a gas processing system.

2. Background Information

After extracting fossil fuel from an in-ground well, the fossil fuel must be processed in a gas processing system before it can be sold to and consumed by the public. Many types of gas processing systems are known to exist, and there are a variety of components in gas processing systems.

One common component in a gas processing system is a separator. A separator is a pressure vessel configured to separate fuel from the non-fuel matter, such as particulates and water that are extracted with the fossil fuel from the well head during the gas extraction process. Some gas processing systems include two or more separators, such as a first high pressure separator and a second lower pressure separator. They cooperate to route separated and processed gas to a sales pipeline for consumption.

### SUMMARY

Issues continue to exist with gas processing systems that include two separators. These separators are large devices and often take up a significant amount of space which increases costs of materials for housing components, shipping/transport costs associated with moving large items, amongst other things, for both consumers and suppliers in the gas processing industry. The present invention addresses these and other issues.

In one aspect, the invention may provide a gas processing apparatus comprising: a first gas processing vessel; and a second gas processing vessel positioned above the first vessel, the first and second vessels configured to separate fuel from non-fuel in a footprint area as the fuel moves from upstream to downstream through a gas processing system.

In another aspect, the invention may provide at least two gas processing pressure vessels positioned above a single pressure vessel footprint area, the at least two vessels configured to process fuel moving from upstream to downstream through a gas processing system.

In yet another aspect, an embodiment of the invention may provide a method of use for a stacked gas processing vessel comprising the steps of: moving fuel into a first gas processing vessel through an inlet; moving fuel out of the first gas processing vessel through an outlet; moving fuel vertically towards a second gas processing vessel; moving fuel into the second gas processing vessel through an inlet; and moving fuel out of the second gas processing vessel through an outlet.

In another aspect, an embodiment of the invention may provide a method of use for stacked gas processing separators comprising the steps of: providing at least two gas separators configured to process fuel moving through a gas processing system by separating fuel matter from non-fuel matter; and positioning the two separators above a footprint area to form a vertically stacked configuration, the footprint area generally defined as the length of about one separator multiplied by the width of about one separator, the footprint area on a floor with a floor width less than a width of two separators in a side-by-side configuration.

In another aspect, the invention may provide a gas processing apparatus that includes two pressure vessels, or two separators, above a single vessel footprint area in a vertically stacked configuration. The stacked configuration permits the processing of gas to occur in a space having less length or less width than that of two separators arranged tip-to-end or side-by-side, respectively. The first and second separators are configured to separate fuel from non-fuel in a footprint area of a single gas separator as the fuel moves from upstream to downstream through a gas processing system. Further, the gas processing apparatus of the present invention permits the two separators to fit in a housing compartment that is more easily transportable via tractor-trailer.

### BRIEF DESCRIPTION OF THE SEVERAL VIEWS OF THE DRAWINGS

A sample embodiment of the invention, illustrative of the best mode in which Applicant contemplates applying the principles, is set forth in the following description, is shown in the drawings and is particularly and distinctly pointed out and set forth in the appended claims. The accompanying drawings, which are incorporated in and constitute a part of the specification, illustrate various example methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a side elevation view of a gas processing apparatus of the present invention depicting two pressure vessels, a first separator and a second separator, in a vertically stacked configuration;

FIG. 2 is a top view of the gas processing apparatus shown installed in a housing;

FIG. 3 is a side elevation view of the gas processing apparatus shown installed in the housing;

FIG. 4 is an end elevation view of the gas processing apparatus shown installed in the housing;

FIG. 5 is an end elevation view of an alternative embodiment of the present invention depicting a gas processing apparatus including offset stacked separators installed in the housing;

FIG. 6 is a first schematic view depicting the first and second separators of the gas processing apparatus connected via pipeline in a series configuration; and

FIG. 7 is a second schematic view depicting the first and second separators of the gas processing apparatus connected via pipeline in a series configuration with a heating unit positioned downstream from the first separator and upstream from the second separator.

Similar numbers refer to similar parts throughout the drawings.

### DETAILED DESCRIPTION

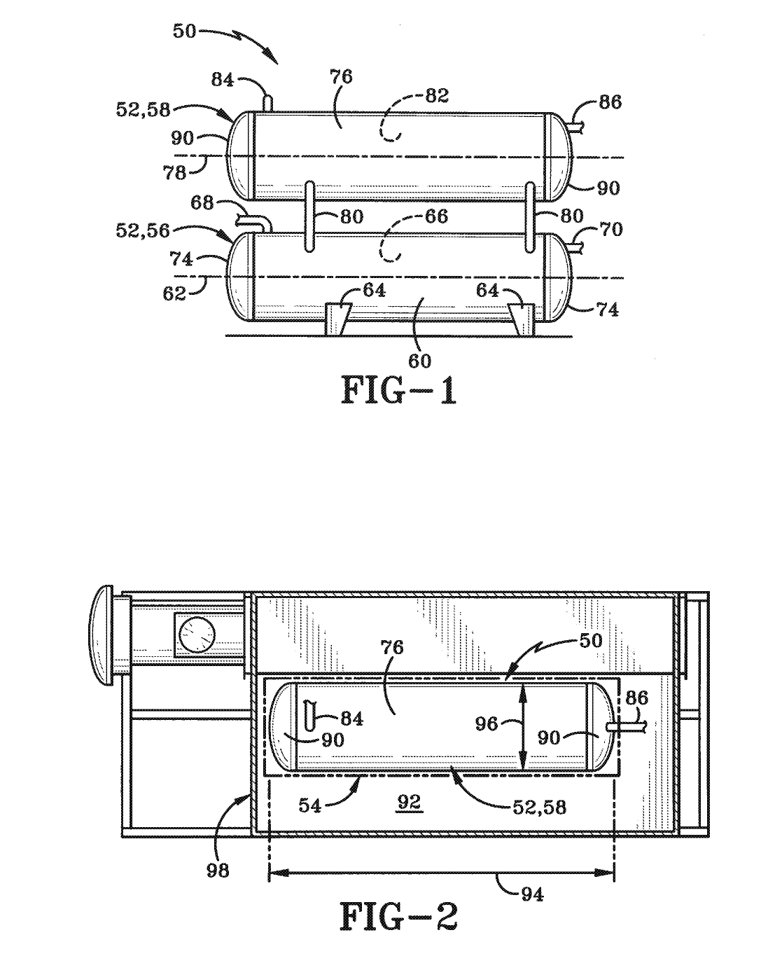

As depicted in FIG. 1, a gas processing apparatus 50 of the present invention includes at least two gas processing pressure vessels 52 positioned above a single pressure vessel footprint area 54 (FIG. 2). The at least two pressure vessels 52 are configured to process fuel moving from upstream to downstream through a gas processing system. In one particular embodiment of the gas processing apparatus 50, the least two gas processing pressure vessels 52 include a longitudinally oriented first separator 56 and a longitudinally oriented second separator 58.

With continued reference to FIG. 1, first separator 56 includes a generally cylindrical vessel body 60 extending along a longitudinal axis 62 and supported by a frame 64. Vessel body 60 defines a chamber 66 for therein separating fuel from non-fuel (particulates and non-fuel liquids such as water) as fuel is moved from upstream to downstream through the separator inlet 68 and outlet 70, respectively, as one having ordinarily skill in the fossil fuel or gas processing field would understand. A separator radius 72 (FIG. 4) extends from longitudinal axis 62 to inner surface of vessel body 60. In the shown embodiment, cylindrical vessel body 60 of first separator includes an outer circumferential surface capped at each end with hemispherical ends 74.

The second separator 58 is configured similarly to the first separator 56 and includes a generally cylindrical vessel body 76 extending along a longitudinal axis 78 and supported by a frame 80. Vessel body 76 defines a chamber 82 for therein separating fuel from non-fuel as fuel is moved from upstream to downstream through the separator inlet 84 and outlet 86, respectively, as one having ordinarily skill in the gas processing field would understand. A second separator radius 88 (FIG. 4) extends from longitudinal axis 78 to inner surface of vessel body 76. In the shown embodiment, cylindrical vessel body 76 of second separator 58 includes an outer circumferential surface capped at each end with hemispherical end caps 90.

As depicted in FIG. 2, first and second separators 56, 58 are mounted to a platform or floor surface 92 above the footprint area 54. The footprint area 54 is on the floor surface 92 and generally defined as the space directly beneath the first separator 56 equal to the length 94 of the first separator multiplied by the width 96 of the first separator 56. Platform 92 is on a gas processing box-housing 98 for containing the gas processing apparatus 50 of the present invention therein. The housing 98 may also retain therein additional elements ordinarily associated with a gas processing system, by way of non-limiting example, valves, hoses, gauges, or pressure chokes. One exemplary housing 98 is detailed in the patent application filed on equal date herewith in the name of the same inventors and assigned to the same original assignee as this disclosure entitled “A HOUSING FOR A GAS PROCESSING APPARATUS,” the entirety of which is hereby incorporated by reference as if fully rewritten herein.

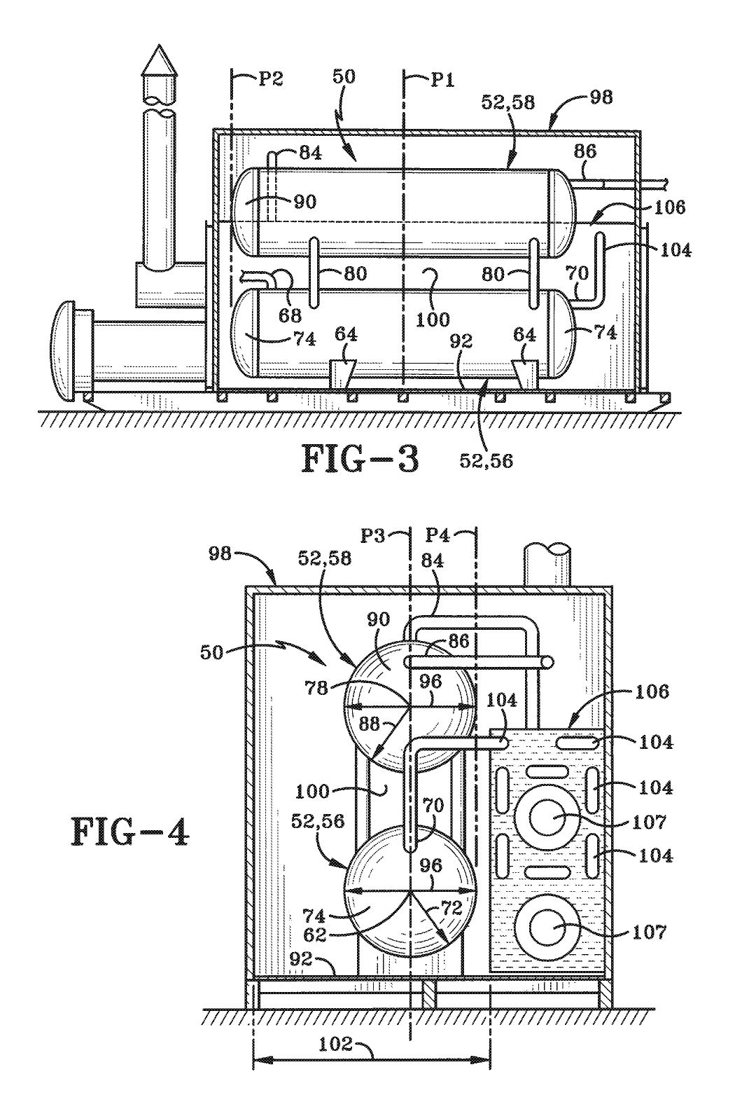

As depicted in FIG. 3, when the gas processing apparatus is mounted on the platform 92 above the footprint area 54, a section of the first separator 56 is radially coplanar with a section on the second separator 58 along a radial plane P1. Further in one particular embodiment, a surface on the first separator 56, such as the tip of the first separator hemispheric end cap 74, is in the same radial plane P2 or radially coplanar with a surface on the second separator 58, such as the tip of the second separator hemispheric end cap 90.

As depicted in FIG. 4, when the gas processing apparatus is mounted on the platform 92 above the footprint area 54 in the housing 98, the longitudinal axis 62 of the first separator 56 and the longitudinal axis 78 of the second separator 58 are axially coplanar along an axial plane P3. Further in one particular embodiment, an axially extending outer surface on the first separator 56, such as vessel body outer surface on the first separator 56, is in the same axial plane P4 or axially coplanar with an outer surface on the second separator 58, such as the vessel body outer surface on the second separator 58.

With continued reference to FIG. 4, an inter-vessel space is defined between the two pressure vessels (first separator 56 and second separator 58). The bottom of the inter-vessel space is bound by the top circumferential outer surface on the first separator 56. The top of the inter-vessel space is bound by the bottom circumferential outer surface on the second separator 58.

These respective radial (FIG. 3) and longitudinal (FIG. 4) coplanar configurations ensure the second separator 58 alignment directly above first separator 56, and the stacked two separators are above the footprint area 54 of a single separator. In the shown embodiments, first and second separators have similar dimensions, yet there may be instances where the second or upper vessel may have a smaller diameter, which would permit the longitudinal axis of the second separator to be offset from a first separator axial plane while still being located above the first separator in the footprint area. The outer surfaces may remain coplanar along plane P4 even though there are different radiuses. Similarly, the outer surfaces may remain coplanar along plane P2 even though upper separator may have a different (i.e., shorter) length than the first separator 56.

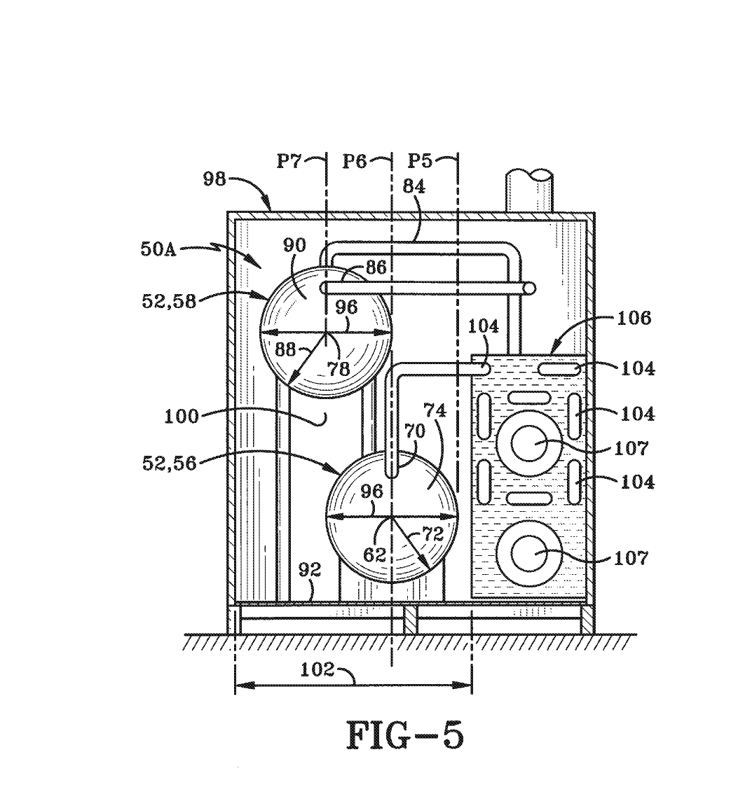

As depicted in FIG. 5, an alternate embodiment of the present invention includes stacked separators 50A wherein the top of first separator 56 is adjacent the bottom of second separator 58. In this way, the two separators 56, 58 are not directly vertical. Separators 56, 58 may be slightly offset from each other while second separator 58 still is generally above first separator 56. In this embodiment, the right outer circumferential of edge of the first separator 56 is in plane P5. The centerline axis 62 of first separator 56 is coplanar with the outer circumferential edge of second separator 58 in plane P6. The centerline axis 78 of second separator 58 is coplanar with a left outer circumferential edge of first separator 56 in plane P7.

In accordance with an aspect of the present invention, the gas processing apparatus including two pressure vessels 52, or two separators, above a single vessel footprint area permits the processing of gas to occur in a space having less length and less width than that of two separators arranged tip-to-end or side-by-side, respectively. The gas processing apparatus of the present invention permits the two separators 52 to fit in a housing 98 compartment that is more easily transportable via tractor-trailer, since the gas processing apparatus 50 occupies less longitudinal distance and less width distance than two separators arranged tip-to-end or side-by-side, respectively. While the stacked configuration of two gas separators 52 disclosed herein may have a larger height than a tip-to-end or a side-by-side arrangement of two separators, tractor-trailer size limitations ordinarily are more limited by length and width, rather than height.

In operation and as detailed throughout FIGS. 2-5, a method for use of the stacked gas processing separator apparatus 50 of the present invention includes the steps of: providing at least two gas separators 52 configured to process fuel moving through a gas processing system by separating fuel matter from non-fuel matter; and positioning the two separators 52 above a single separator footprint area 54 to form a vertically stacked configuration, the footprint area 54 generally defined as the length 94 of about one separator multiplied by the width 96 of about one separator. Then, installing the stacked two separators in a box-housing 98, wherein the box-housing has a floor width 102 (FIG. 5) less than the combined width of the two separators if they were in a side-by-side configuration. Stated otherwise, the sum of width 96 of the two separators 56, 58 is greater than the floor width 102.

In operation and as detailed in the schematic of FIG. 6, first separator 56 and second separator 58 are connected via gas pipeline 104 in a series configuration wherein the first separator 56 is upstream from the second separator 58. Fossil fuels extracted from a well are processed moving downstream through a gas processing system in the pipeline 104 into the first separator 56 through inlet 68 (FIG. 3) wherein fuel is separated from non-fuels and exits through outlet 70 (FIG. 3). Fuel then moves in an angled direction between −90 and 90 degrees relative to horizontal. Preferably the fuel moves between 45 and 90 degrees upward from first separator 56 to second separator 58. Alternatively, the separators 56, 58 could be arranged such that the fuel moves downward between first and second separators. The fuel continues to flow via pipeline 104 into second separator 56 through inlet 84 (FIG. 3) wherein the fuel is separated again from any remaining non-fuel that remained after flowing through the first separator 56. Fuel exits second separator 58 through outlet 86 (FIG. 3) and flows downstream through the remaining portions of the gas processing system. While the schematic of FIG. 6 is shown in a linear relationship, this only represents the series configuration of the two separators and the actual physical arrangement of the two separators will be vertically above the single footprint area.

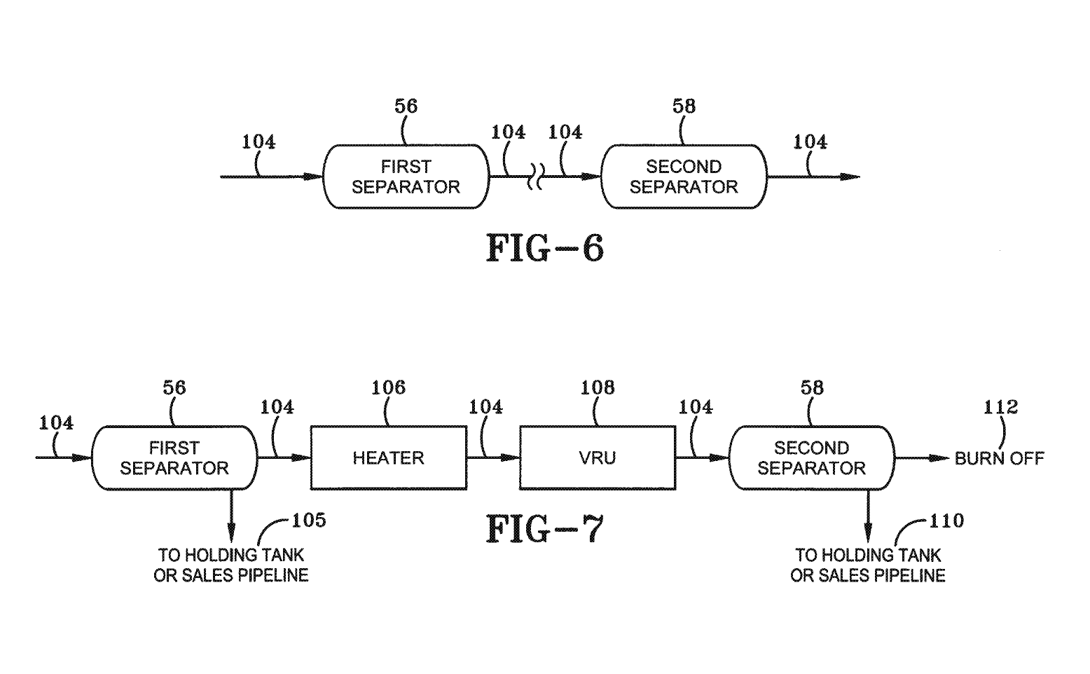

In operation and as detailed in the schematic of FIG. 7, fuel moves from a well through a gas processing system via pipeline 104 where the fuel is separated from a non-fuel in the first separator 56. In this particular embodiment, non-fuel refers to particulates and non-fuel liquids such as water. A first amount of separated fuel is then metered off in a metering device and sent to a downstream destination such as a holding tank or a sales pipeline 105. A second amount of the fuel is sent to a heating unit 106. The second amount of fuel is heated in the heating unit 106 via submerged element 107 to create a fuel vapor. The fuel vapor is then sent downstream via pipeline 104 to a vapor recovery unit. The fuel vapors are separated from any remaining non-fuel vapors in the second separator 58. From the second separator outlet the separated fuel vapors may flow to and be recovered in an additional vapor recovery unit. After recovering the fuel vapor, the second amount of fuel may be metered through outlet leading to a holding tank or sales line 110, or may be sent to a flume stack 112 to be burned off. Again, while the schematic of FIG. 7 is shown in a linear relationship, this only represents the series configuration of the two separators and the heating unit positioned between the two separators. In one particular embodiment, the actual physical arrangement of the two separators will be vertically above the single footprint area, and the heating unit will be adjacent the two stacked separators outside the footprint area.

Further, the broken lines along pipeline indicated in schematic views FIGS. 6-7 indicate that additional gas processing components may be located between the identified components of the present invention along the gas processing stream as one in the art would comprehend.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the preferred embodiment of the invention are an example and the invention is not limited to the exact details shown or described.

What is claimed:

1. A gas processing apparatus comprising:
a first gas processing vessel; and
a second gas processing vessel positioned above the first vessel, the first and second vessels configured to separate fuel from non-fuel in a footprint area as the fuel moves from upstream to downstream through a gas processing system.

2. The gas processing apparatus of claim 1 wherein the footprint area is generally equal to the area of the second vessel.

3. The gas processing apparatus of claim 1, further comprising:
a first gas separator associated with the first gas vessel; and
a second gas separator associated with the second gas vessel.

4. The gas processing apparatus of claim 1, further comprising:
a longitudinal first vessel axis;
a longitudinal second vessel axis axially coplanar with the first vessel axis.

5. The gas processing apparatus of claim 1, further comprising:
a longitudinal first vessel axis; and
a longitudinal second vessel axis offset from the first vessel axis.

6. The gas processing apparatus of claim 1, further comprising:
a first section on the first vessel;
a second section on the second vessel radially coplanar with the first section.

7. The gas processing apparatus of claim 1, further comprising:
an outer surface on the first vessel;
an outer surface on the second vessel axially coplanar with the first vessel outer surface.

8. The gas processing apparatus of claim 1, further comprising:
a top surface on the first vessel and a bottom surface on the second vessel defining an inter-vessel space therebetween; and
pipeline extending through the inter-vessel space.

9. The gas processing apparatus of claim 1, further comprising:
a top surface on the first vessel adjacent a bottom surface on the second vessel.

10. The gas processing apparatus of claim 1, further comprising:
pipeline connecting the first vessel to the second vessel in a series configuration, wherein the first vessel is upstream from the second vessel.

11. The gas processing apparatus of claim 1 wherein the first gas processing vessel is aligned directly above the second gas processing vessel.

12. The gas processing apparatus of claim 1, further comprising:
a heating unit connected via pipeline to the first and second vessels;
wherein the first vessel is upstream from the heating unit; and
the second vessel downstream from heating unit.

13. The gas processing apparatus of claim 12, further comprising:
a vapor recovery unit connected via pipeline to the first and second vessels;
wherein the first vessel is upstream from the heating unit and the vapor recovery unit; and
wherein the second vessel is downstream from heating unit and the vapor recovery unit.

14. A method of use for a stacked gas processing vessel comprising the steps of:
moving fuel into a first gas processing vessel through an inlet;
moving fuel out of the first gas processing vessel through an outlet;
moving fuel vertically towards a second gas processing vessel;
moving fuel into the second gas processing vessel through an inlet; and
moving fuel out of the second gas processing vessel through an outlet.

15. The method of claim 14 wherein the step of moving gas vertically is accomplished by moving the gas at an angle between −90 degrees and 90 degrees relative to horizontal.

16. The method of claim 15 where the angle is between 45 degrees and 90 degrees relative to horizontal.

17. The method of claim 14, further comprising the steps of:
separating fuel from non-fuel in the first vessel;
metering the fuel in a metering device and sending a first amount of fuel to an outlet on a housing and a second amount of fuel to a heating unit;
heating the second amount of fuel to create a vapor; and
separating fuel vapors from non-fuel vapors in the second vessel.

18. The method of claim 17, further comprising the step of recovering fuel from fuel vapors in a vapor recovery unit.

19. The method of claim 14, prior to the step of moving gas into the first vessel comprises the step of:
moving fuel through a sidewall defined aperture on a gas processing box-like housing including the first and second vessels in a stacked configuration.

20. A method of use for stacked gas processing separators comprising the steps of:
providing at least two gas separators configured to process fuel moving through a gas processing system by separating fuel matter from non-fuel matter; and
positioning the two separators above a footprint area to form a vertically stacked configuration, the footprint area generally defined as the length of about one separator multiplied by the width of about one separator, the footprint area on a floor with a floor width less than a width of two separators in a side-by-side configuration.
